(19) United States
(12) Patent Application Publication
(10) Pub. No.: US 2009/0324177 A1
(43) Pub. Date: Dec. 31, 2009

(54) FIBER OPTIC CABLE SPLICE AND CABLE RECONSTRUCTION

(76) Inventors: Charles Qian, Gilbert, AZ (US); Katherine X. Liu, Tucson, AZ (US)

Correspondence Address: Katherine Liu, PO Box 37221, Tucson, AZ, 85740, US

(21) Appl. No.: 12/124,409

(22) Filed: May 21, 2008

Related U.S. Application Data
(63) Continuation-in-part of application No. 11/805,742, filed on May 24, 2007, now Pat. No. 7,410,308.
Application No. 11/805,742 is a continuation-in-part of application No. 11/329,413, filed on Jan. 9, 2006, now Pat. No. 7,306,382.

(51) Int. Cl. G02B 6/255

(52) U.S. Cl. 385/95; 385/99

(57) ABSTRACT

A new fiber optic cable splice for splicing optical fiber cables together and reconstructing fiber-optic cable that provide substantially enhanced reliability and broadened operating temperature range is disclosed. The disclosed cable splice offer reliable and user friendly solutions to applications in many harsh environments such as avionics, field vehicles, and defense related instrumentation. The cable splice consists of a preassembled one piece splice core and outer mechanical and thermal shielding layers. A simple splicing procedure and key fixtures are also disclosed.

### RELATED CASES/PRIORITY CLAIM

This application is a continuation-in-part and claims priority under 35 USC 120 to pending application Ser. No. 11/805,742 filed on My 24, 2007 and entitled “Fiber optic cable splice”, which is a continuation-in-part to an utility patent application Ser. No. 11/329,413 filed on Jan. 9, 2006 and entitled “Apparatus and Method for Splicing Optical Fibers and Reconstructing Fiber-optic Cables” that was later issued with U.S. Pat. No. 7,306,382 on Dec. 11, 2007 and entitled “Mechanical splice optical fiber connector.” The Prior applications are incorporated herein by way of reference.

### GOVERNMENT SUPPORT

This invention was made with Government support under contract No. N68335-05-C-0140 awarded by the Department of Defense. The Government may have certain rights in the invention.

### BACKGROUND OF THE INVENTION

1. Field of the Invention

The present invention relates generally to the field of optical fiber communication and more particularly to the reconstruction of an optical fiber cable.

2. Background Art

In the past decade, applications involving optical fiber based communication systems are becoming more practical and are gradually replacing copper based systems. A common task required by these applications is to repair damaged fiber optic cables. There are three prior art technologies that are used to repair fiber-optic cables and the most relevant patents to this invention appear to be the one by Thomas Scanzillo, Aug. 10, 2004, U.S. Pat. No. 6,773,167; by Toshiyuki Tanaka, Oct. 5, 1999, U.S. Pat. No. 5,963,699 and by Bruno Daguet, and by Gery Marlier, May 24, 1994, U.S. Pat. No. 5,315,682. These patents are thereby included herein by way of reference.

A typical prior art fusion spliced optical fiber is illustrated in FIG. 1. The splice consists of an input optical fiber 110 with a protective coating 120, and an output optical fiber 115 with a protective coating 125. The optical fibers are joined at the interface 130 using an automated apparatus following precision alignment and discharge induced fusion splicing process. In order to protect the splicing region, a rigid rod 150 is used and typically the splice and the rigid rod are both enclosed in a heat shrinking enclosure 140.

An alternative prior art mechanical fiber-optic splice is illustrated in FIG. 2. The splice consists of an input optical fiber 210 with a protective coating 220, and an output optical fiber 215 with a protective coating 225, a capillary glass tube 250 containing a precision through channel, placed inside of a protective outer tube 240 and with protective end caps 260 and 265. Typically, the input and output fibers are placed inside of the glass capillary, an index matching fluid 230 is used to form an air free contact. For certain splices, there is an added small perpendicular channel in the capillary tube 255. To aid the fiber insertion into the glass capillary tube, two ends of the capillary tube are normally tapered to form interfacing cones. The inner diameter of the capillary tube is made substantially close to the outer diameter of the optical fiber with typical tolerances within one micrometer for a single-mode fiber splice, and a few micrometers for a multimode fiber splice. The index matching fluid is transparent and has a refractive index very close to that of the core of the optical fiber. Frequently, the optical fiber and splice interfaces are further protected by flexible boots 270 and 275. The prior art fiber splice is often protected with a plastic outer package (not shown) for mechanical stability.

A related prior art fiber optic cable is illustrated in FIG. 3. The cable consists of a coating protected optical fiber 310, a buffer tube 320, a layer of cable strengthening fibers 380 and an outer jacket 390. These cables are designed for reliable operation in challenging environments.

Although most of the commercially available fiber optic splices do not reconstruct the broken fiber optic cable, prior arts do exist for undersea cable reconstruction. In such a case, reconstruction is typically welded, very bulky and extensive to protect splice from extreme undersea water pressure. Due to the small temperature fluctuations in the undersea environment, materials with substantially different coefficient of thermal expansion (e.g., copper and stainless steel) can be employed without compromising device reliability.

These prior art approaches have several areas for improvements. For example, the plastic protective outer package of an optical fiber splice has a very limited range of operating temperature. Furthermore, in avionics applications, a fast temperature-cycled environment requires additional packaging considerations to ensure stable and reliable operations. Additionally, in order to splice fiber optic cable such as the one illustrated in FIG. 3, one must have structure improvements such that the mechanical and chemical resistance properties of the cable be restored. Such a restoration needs to have a compact packaging, mechanical and chemical integrity, as well as a thermal protection from a fast changing environmental temperature. There is a need, therefore, to make improvements to these prior art approaches, so that highly reliable fiber-optic cable splices and reconstructed fiber-optic cables can be realized.

### SUMMARY OF THE INVENTION

The present invention discloses a design of a fiber-optic cable splice that enables fiber-optic cable reconstruction and restores optical signal connection. The new fiber-optic cable splice provides substantially enhanced mechanical and chemical reliability in a temperature cycled environment. The new splice can be employed in applications in many areas such as avionics, automobile and defense related instrumentation. Key fixtures and procedure associated with splice installation are also disclosed.

### BRIEF DESCRIPTION OF THE DRAWINGS

The aforementioned objects and advantages of the present invention, as well as additional objects and advantages thereof, will be more fully understood hereinafter as a result of a detailed description of a preferred embodiment when taken in conjunction with the following drawings in which:

FIG. 1 shows the structure of a prior art fusion spliced optical fiber;

FIG. 2 displays the structure of a prior art mechanical fiber-optic splice;

FIG. 3 illustrates the cross sectional view of a high quality prior art fiber-optic cable;

FIG. 4 depicts the cross sectional view of an improved fiber-optic cable splice incorporating a structure for cable reconstruction;

FIG. 5 shows the cross sectional view of an improved fiber-optic cable splice incorporating a structure for reconstructed cable and further incorporating thermal and mechanical stress reduction elements;

FIG. 6 displays the cross sectional view of an improved fiber-optic cable splice incorporating a structure for reconstructed cable and further incorporating thermal, mechanical and environmental stress reduction elements;

FIG. 7 illustrates an improved cable splice fixture consisting of base plate, Funnel like opening to aid the insertion of an optic fiber cable.

FIG. 8 shows an improved cable splice fixture consisting of an enclosure, and UV LED light sources for curing the index-matching fluid.

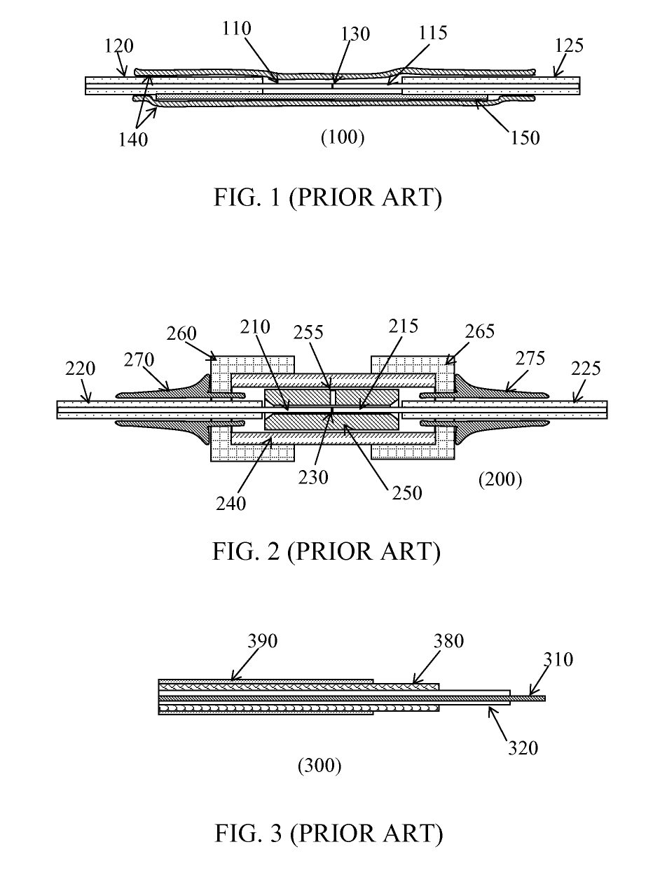

### DETAILED DESCRIPTION OF THE INVENTION

The present invention discloses the design of a new fiber optic cable splice to obtain a highly reliable mechanically reconstructed fiber-optic cable. The new approach departs from the prior art practice of directly splicing fiber-optic cables. The basic concept is to introduce a compact, leak-tight, thermally shielded, and mechanically robust outer package. In addition, light-cured index matching fluid may be used to permanently fix the optical fibers to the glass capillary. The new approach provides a highly reliable reconstructed fiber-optic cable for hash environment and rough handling.

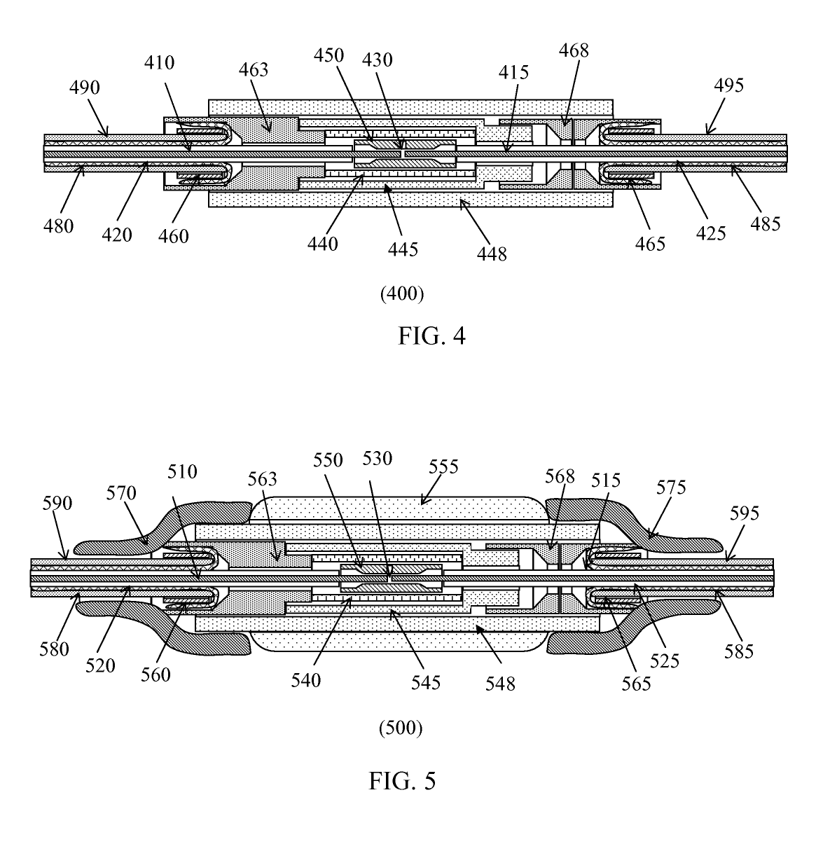

The first preferred embodiment of the present invention 400 is illustrated in FIG. 4. The core of a reconstructed fiber-optic cable splice consists of an input optical fiber 410 with an outer protective tube 420, an output optical fiber 415 with an outer protective tube 425, and a glass capillary tube 450 with a precision capillary channel, and two cable-splice bridging flanges 463 and 468. The glass capillary tube 450 is preferably enclosed by a protective tube 440. To enhance the stability of the splice and reduce fiber breakage during assembly, a metallic enclosure with a threaded end 445 is preferred. Correspondingly, one of the cable-splice bridging flanges (468 as in FIG. 4) is assembled from two sections; the front section has a threaded tube which interfaces with the metallic enclosure 445 whereas the tail section accommodates the fiber optic cable. The two sections of 468 are coupled in such a way that rotating the front section will only translate the fiber optic cable without substantially rotating it. Typically, the ends of the optical fibers are stripped and cleaved according to splicing specifications. The ends are then inserted into the capillary tube. To aid the splicing process, the ends of the capillary tube are tapered to allow for the ease of the insertion of the optical fibers and to accommodate the protective tubes outside of the optical fiber. Light-cured index matching fluid can preferably be introduced inside of the capillary tube between the optical fiber ends 430 to be spliced, and be cured once a desired insertion loss target is achieved. Typically the inner diameter of the capillary tube is very close to the outer diameter of the optical fiber. For single mode optical fibers, the capillary inner diameter is within one micrometer of the fiber diameter, whereas for multimode fibers it is within a few micrometers. In order to restore mechanical strength of the fiber-optic cable, the input cable strengthening fibers 480 are crimped between the cable-splice bridging flange 463 and an inner tube 460. Similarly the output fiber-optic cable strengthening fibers 485 are crimped in between the bridging flange 468 and its inner tube 465. For enhanced mechanical properties of the splice, it is preferable to have these inner tubes crimped to the jacket of the fiber optic cable prior to cable insertions into the splice core. The mechanical property of the fiber optic cable is restored by crimping an outer tube 448 with both input bridging flange 463 and output bridging flange 468, at respective locations.

The second preferred embodiment of the present invention 500 is illustrated in FIG. 5. The core of a reconstructed fiber-optic cable splice consists of an input optical fiber 510 with an outer protective tube 520, an output optical fiber 515 with an outer protective tube 525, and a glass capillary tube 550 with a precision capillary channel, and two cable-splice bridging flanges 563 and 568. The glass capillary tube 550 is preferably enclosed by a protective tube 540. To enhance the stability of the splice and reduce fiber breakage during assembly, a metallic enclosure 545 with a threaded end is preferred. Correspondingly, one of the cable-splice bridging flanges (568 as in FIG. 5) is assembled from two sections; the front section has a threaded tube which interfaces with the metallic enclosure 545 whereas the tail section accommodates the fiber optic cable. The two sections of 568 are coupled in such a way that rotating the front section will only translate the fiber optic cable without substantially rotating it. Typically, the ends of the optical fibers are stripped and cleaved according to splicing specifications. The ends are then inserted into the capillary tube. To aid the splicing process, the ends of the capillary tube are tapered to allow for the ease of the insertion of the optical fibers and to accommodate the loose tubes outside of the optical fiber. Light-cured index matching fluid can preferably be introduced inside of the capillary tube between the optical fiber ends 530 to be spliced, and be cured once a desired insertion loss target is achieved. Typically the inner diameter of the capillary tube is very close to the outer diameter of the optical fiber. For single mode optical fibers, the capillary inner diameter is within one micrometer of the fiber diameter, whereas for multimode fibers it is within a few micrometers. In order to restore mechanical strength of the fiber-optic cable, the input cable strengthening fibers 580 are crimped between the cable-splice bridging flange 563 and an inner tube 560. Similarly the output fiber-optic cable strengthening fibers 585 are crimped in between a bridging flange 568 and corresponding inner tube 565. For enhanced mechanical properties of the splice, it is preferable to have these inner tubes crimped to the jacket of the fiber optic cable prior to cable insertions into the splice core. The mechanical property of the fiber optic cable is restored by crimping an outer tube 545 with both input bridging flange 563 and output bridging flange 568, at respective locations. In order to improve thermal and mechanical properties of the splice, a thermal insulating tube 555 is placed outside of the splice core whereas two flexible boots 570 and 575 are used to protect the cable-splice interface regions.

The third preferred embodiment of the present invention 600 is illustrated in FIG. 6. The core of a reconstructed fiber-optic cable splice consists of an input optical fiber 610 with an outer protective tube 620, an output optical fiber 615 with an outer protective tube 625, and a glass capillary tube 650 with a precision capillary channel, and two cable-splice bridging flanges 663 and 668. The glass capillary tube 650 is preferably enclosed by a protective tube 640. To enhance the stability of the splice and reduce fiber breakage during assembly, a metallic enclosure with a threaded end 645 is preferred. Correspondingly, one of the cable-splice bridging flanges (668 as in FIG. 6) is assembled from two sections; the front section has a threaded tube which interfaces with the metallic enclosure 645 whereas the tail section accommodates the fiber optic cable. The two sections of 668 are coupled in such a way that rotating the front section will only translate the fiber optic cable without substantially rotating it. Typically, the ends of the optical fibers are stripped and cleaved according to splicing specifications. The ends are then inserted into the capillary tube. To aid the splicing process, the ends of the capillary tube are tapered to allow for the ease of the insertion of the optical fibers and to accommodate the protection tubes outside of the optical fiber. Light-cured index matching fluid can preferably be introduced inside of the capillary tube between the optical fiber ends to be spliced, and be cured once a desired insertion loss target is achieved. Typically the inner diameter of the capillary tube is very close to the outer diameter of the optical fiber. For single mode optical fibers, the capillary inner diameter is within one micrometer of the fiber diameter, whereas for multimode fibers it is within a few micrometers. In order to restore mechanical strength of the fiber-optic cable, the input cable strengthening fibers 680 are crimped between the cable-splice bridging flange 663 and an inner tube 660. Similarly the output fiber-optic cable strengthening fibers 685 are crimped in between a bridging flange 668 and corresponding inner tube 665. For enhanced mechanical properties of the splice, it is preferable to have these inner tubes crimped to the jacket of the fiber optic cable prior to cable insertions into the splice core. The mechanical property of the fiber optic cable is restored by crimping an outer tube 645 with both input bridging flange 663 and output bridging flange 668, at respective locations. In order to improve thermal and mechanical properties of the splice, a thermal insulating tube 655 is placed outside of the splice core whereas two flexible boots 670 and 675 are used to protect the cable-splice interface regions. The splice is further protected by a heat shrinking outer tube 678.

In the disclosed preferred embodiments outlined above, typically, the metallic parts (445, 448, 463, 468, 545, 548, 563, 568, 645, 648, 663, and 668) are preferably made with low thermal expansion alloys such as Invar which is a commercially available alloy formed primarily of iron and nickel, and Kovar which is a commercially available alloy formed primarily of nickel, cobalt and iron. The flexible boots (570, 575, 670, 675) are made of rubber materials that can withstand extreme temperature conditions (from −60 to 150° C.). The protection tube enclosing the glass capillary (440, 540, 640) can be made from Teflon like materials such as PTFE(poly tetra fluoro ethylene), PFA(perfluoro alkoxy), FEP(fluorinated ethylene propylene) and ETFE(ethylene tetra fluoro ethylene). The insulating layer (555 and 655) can be made with materials such as insulation fiberglass or Teflon fibers.

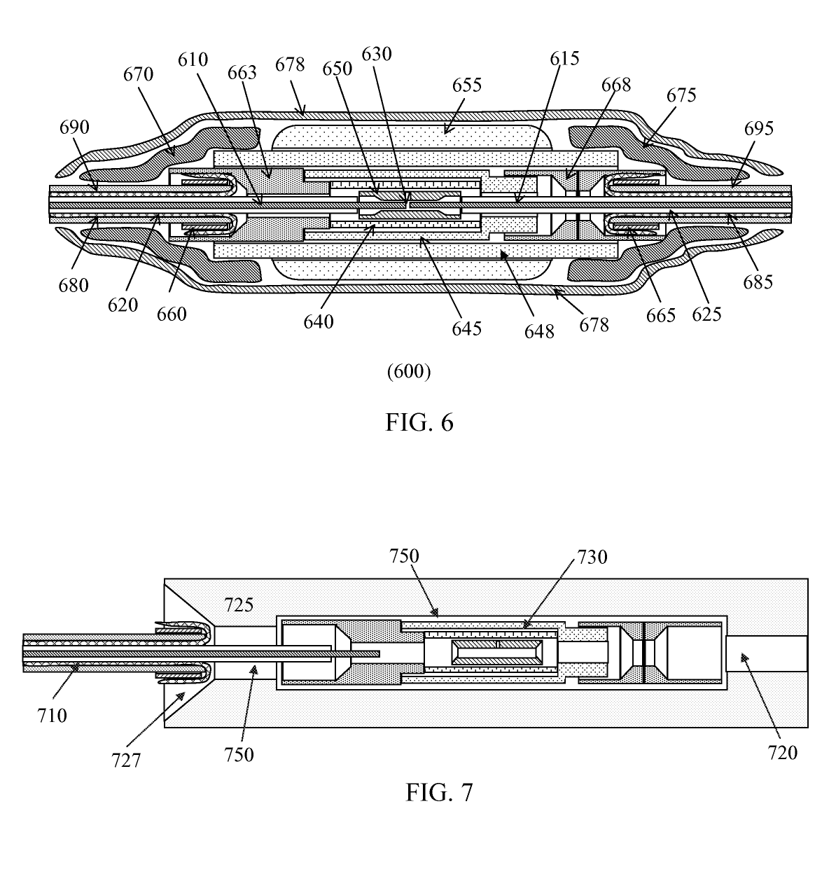

The forth preferred embodiment of the present invention is illustrated in FIG. 7. The alignment fixture of the fiber optic splice consists of two base plates 725 (only one is shown). The structure of the base plate contains a fennel like opening 727 to aid fiber cable 710 insertion, a narrower channel to allow for the alignment of the fiber cable end with the cable splice core 730, a larger chamber 750 that fits the splice core with precision, and an exit channel 720 for through optical fiber cable (not shown) in a partially (half) assembled cable splice (i.e., one of the cable already inserted and crimped). In a preferred arrangement, two of the base plates are placed together to form axially symmetric cavities which can enclose the cable splice core and fiber cable, also enable the insertion of an optic fiber cable end to be spliced. The two base plates can be separated which releases the partially made splice and allowing user to crimp the optical fiber cable to the cable splice core. Additionally, the two base plates are preferably attached to a mechanical clip wherein the opening of the clip allows for the loading of the splice core and the release of the partially assembled splice. When the clip is closed, the two base plates are brought together to form an alignment fixture where optic fiber cable ends can be inserted into the splice core as illustrated in FIG. 7.

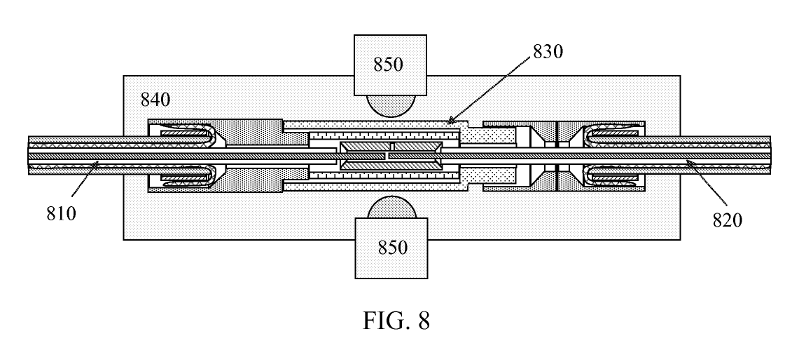

In an additional preferred embodiment, as shown in FIG. 8, a partially assembled cable splice 830 containing an input 810 and an output 820 optical fiber cables is placed in an enclosure 840 where UV-LED are placed closely to the splice core to cure the index matching fluid. Following the curing step, the index matching liquid is converted to an index matching solid which also bonds the two ends of the optical fiber cables together. Typical index matching liquids are optical adhesives such as NOA61 from Norland, OG142-13 from Epotek, and UV15 from Master Bond.

Although UV-curable index matching fluid is preferred in the disclosed cable splice embodiments described above, other index matching fluids which do not need curing may also be preferred in certain applications.

A typical preferred optical fiber cable splicing procedure consists of the following steps which can be carried out in certain logical order: (a) placing outer packaging materials through the cable (heat shrink tube, rubber boots, thermal insulation, and outer crimping tube); (b) insertion of the optical fiber cable ends through inner tubes and crimp these tubes at specified locations; (c) preparing optical fiber cables for the splicing (stripping outer cable jacket, stripping fiber protection tube, and cleaving optical fiber, all to specified lengths); (d) insertion of one of the optical fiber cable into the splice core with the aid of a fixture; (e) remove the partially inserted cable and splice core from the fixture; (f) complete the insertion of the cable and crimp the cable with respect to the splice core; (g) repeating steps (d), (e), and (f) for the second optical fiber cable; (h) fine tune the distance between the fiber ends to minimize insertion loss; (i) UV cure the partially made splice in a UV curing fixture; (j) assemble and crimp the outer crimp tube to enclose the splice core; (k) assemble thermal insulation, rubber boots; and finally (l) to assemble and heat shrink the heat shrink tube.

It will be apparent to those with ordinary skill of the art that many variations and modifications can be made to the fiber-optic cable splice, fixtures and procedure disclosed herein without departing form the spirit and scope of the present invention. It is therefore intended that the present invention cover the modifications and variations of this invention provided that they come within the scope of the appended claims and their equivalents, we claim:

1. An fiber optic cable splice comprising:
at least an input and an output optical fiber cable;
at least one capillary tube enclosing the ends of input and output optical fibers;
an index matching fluid placed inside of the capillary tube;
a protection tube enclosing the capillary tube;
first and second metallic crimping tubes enclosing the optical fiber cables;
first and second metallic cable-splice bridging flanges each enclosing the first and second metallic crimping tubes and the input and output optical fiber cables respectively;
a third metallic crimping tube enclosing the ends of optical fibers, capillary tube and protection tube, the first and second crimping tubes, and the cable-splice bridging flanges;

2. The fiber optic cable splice recited in claim 1 wherein the input and output optical fiber cables are single mode optical fiber cables.

3. The fiber optic cable splice recited in claim 1 wherein the input and output optical fiber cables are multimode optical fiber cables.

4. The fiber optic cable splice recited in claim 1 wherein the input and output optical fiber cables each have a fiber core diameter of 1 to 500 μm.

5. The fiber optic cable splice recited in claim 1 wherein the input and output optical fiber cables each have a fiber cladding diameter of 5 to 1000 μm.

6. The fiber optic cable splice recited in claim 1 wherein the input and output optical fiber cables each have cable strengthening fibers placed outside of the optical fibers.

7. The fiber optic cable splice recited in claim 6 wherein the input and output optical fiber cables each have a cable outer jacket enclosing the optical fibers and strengthening fibers.

8. The fiber optic cable splice recited in claim 1 wherein the capillary tube is made of fused silica.

9. The fiber optic cable splice recited in claim 1 wherein the capillary tube is made of glass material.

10. The fiber optic cable splice recited in claim 1 wherein the capillary tube has a square capillary cross section.

11. The fiber optic cable splice recited in claim 1 wherein the metallic cable-splice bridging flanges are made of a low thermal expansion alloy formed of nickel, cobalt and iron.

12. The fiber optic cable splice recited in claim 1 wherein the metallic cable-splice bridging flanges are made of a low thermal expansion alloy formed of nickel and iron.

13. The fiber optic cable splice recited in claim 1 wherein the index matching fluid has an index of refraction substantially close to that of the core of the optical fiber.

14. The fiber optic cable splice recited in claim 1 wherein the index matching fluid is a light cured material.

15. The fiber optic cable splice recited in claim 1 wherein the index matching fluid is a heat cured material.

16. The fiber optic cable splice recited in claim 1 wherein the index matching fluid is an air cured material.

17. The fiber optic cable splice recited in claim 1 wherein the protection tube is made of fluorinated polymer material such as polytetrafluoroethylene (PTFE), perfluoroalkoxy (PFA), fluorinated ethylene propylene (FEP), ethylenetetrafluoroethylene (ETFE).

18. The fiber optic cable splice recited in claim 1 wherein the metallic crimping tubes are made of a low thermal expansion alloy formed of nickel, cobalt and iron.

19. The fiber optic cable splice recited in claim 1 wherein the metallic crimping tubes are made of a low thermal expansion alloy formed of nickel and iron.

20. The fiber optic cable splice recited in claim 1 wherein at least one of the metallic cable-splice bridging flanges has a rotation-translation coupling and contains a section with threaded channel.

21. The fiber optic cable splice recited in claim 1 wherein there is an additional metallic protective tube enclosing the capillary tube and its protection tube having at least one threaded end.

22. An fiber optic cable splice comprising:
at least an input and an output optical fiber cable;
at least one capillary tube enclosing the ends of input and output optical fibers;
an index matching fluid placed inside of the capillary tube;
a protection tube enclosing the capillary tube;
first and second metallic crimping tubes enclosing the optical fiber cables;
first and second metallic cable-splice bridging flanges enclosing the first and second metallic crimping tubes and input and output optical fiber cables respectively;
a third metallic crimping tube enclosing the ends of optical fibers, capillary tube and protection tube, the first and second crimping tubes, and the cable-splice bridging flanges;
at least one thermally insulating tube enclosing the capillary tube.

23. The fiber optic cable splice recited in claim 22 wherein the input and output optical fiber cables are single mode optical fiber cables.

24. The fiber optic cable splice recited in claim 22 wherein the input and output optical fiber cables are multimode optical fiber cables.

25. The fiber optic cable splice recited in claim 22 wherein the input and output optical fiber cables each have a fiber core diameter of 1 to 500 μm.

26. The fiber optic cable splice recited in claim 22 wherein the input and output optical fiber cables each have a fiber cladding diameter of 5 to 1000 μm.

27. The fiber optic cable splice recited in claim 22 wherein the input and output optical fiber cables each have cable strengthening fibers placed outside of the optical fibers.

28. The fiber optic cable splice recited in claim 27 wherein the input and output optical fiber cables each have a cable outer jacket enclosing the optical fibers and strengthening fibers.

29. The fiber optic cable splice recited in claim 22 wherein the capillary tube is made of fused silica.

30. The fiber optic cable splice recited in claim 22 wherein the capillary tube is made of glass material.

31. The fiber optic cable splice recited in claim 22 wherein the capillary tube has a square capillary cross section.

32. The fiber optic cable splice recited in claim 22 wherein the metallic cable-splice bridging flanges are made of a low thermal expansion alloy formed of nickel, cobalt and iron.

33. The fiber optic cable splice recited in claim 22 wherein the metallic cable-splice bridging flanges are made of a low thermal expansion alloy formed of nickel and iron.

34. The fiber optic cable splice recited in claim 22 wherein the index matching fluid has an index of refraction substantially close to that of the core of the optical fiber.

35. The fiber optic cable splice recited in claim 22 wherein the index matching fluid is an light cured material.

36. The fiber optic cable splice recited in claim 22 wherein the index matching fluid is a heat cured material.

37. The fiber optic cable splice recited in claim 22 wherein the index matching fluid is an air cured material.

38. The fiber optic cable splice recited in claim 22 wherein the protection tube is made of fluorinated polymer material such as polytetrafluoroethylene (PTFE), perfluoroalkoxy (PFA), fluorinated ethylene propylene (FEP), ethylenetetrafluoroethylene (ETFE).

39. The fiber optic cable splice recited in claim 22 wherein the metallic crimping tubes are made of a low thermal expansion alloy formed of nickel, cobalt and iron.

40. The fiber optic cable splice recited in claim 22 wherein the metallic crimping tubes are made of a low thermal expansion alloy formed of nickel and iron.

41. The fiber optic cable splice recited in claim 22 wherein the thermally insulating tube is made of fiber glass material.

42. The fiber optic cable splice recited in claim 22 wherein the thermally insulating tube is made of Teflon fiber material.

43. The fiber optic cable splice recited in claim 22 wherein at least one of the metallic cable-splice bridging flanges has a rotation-translation coupling and contains a section with threaded channel.

44. The fiber optic cable splice recited in claim 22 wherein there is an additional metallic protective tube enclosing the capillary tube and its protection tube having at least one threaded end.
